(19) United States
(12) Patent Application Publication
(10) Pub. No.: US 2004/0111314 A1
(43) Pub. Date: Jun. 10, 2004

(54) Satisfaction prediction model for consumers

(75) Inventor: Michael Cavaretta, Bloomfield, MI (US)

Correspondence Address: BROOKS KUSHMAN P.C./FGTL, 1000 TOWN CENTER, 22ND FLOOR, SOUTHFIELD, MI, 48075-1238, US

(73) Assignee: Ford Motor Company, Dearborn, MI (US)

(21) Appl. No.: 10/065,410

(22) Filed: Oct. 16, 2002

(51) Int. Cl. G06F 17/60

(52) U.S. Cl. 705/10

(57) ABSTRACT

Methodologies for constructing a satisfaction prediction model for motor vehicle buyers. One method includes presenting a buyer satisfaction survey to a portion of a buyer base for one or more motor vehicles. For each buyer that completes the survey, the buyer's survey response data is joined with the buyer's purchase and warranty claim data to create an aggregate of buyer satisfaction for the portion of the buyer base that completed the survey. Next, a satisfaction prediction model is constructed based on the aggregate of buyer satisfaction. The method may be partially or wholly computer-implemented.

### BACKGROUND OF INVENTION

1. Field of the Invention

This invention relates generally to a methodology for constructing a satisfaction prediction model for motor vehicle buyers.

2. Background Art

Prior art methods of identifying and assessing customer satisfaction typically involve customer surveys. Customer surveys can be presented to and taken by customers in a variety of different manners.

One type of customer survey is a mail survey. Mail surveys are often in the form of a postcard or other paper/letter format. These surveys can be packaged with an item at the time of purchase, or sent directly to a purchaser after the time of sale at predetermined time intervals. Although the customer feedback in presented in mail survey responses is typically very informative, the percentage of customers who complete and return the survey is generally very low in comparison to the number of surveys that are mailed. Accordingly, one drawback of mail surveys is their low level of customer response.

Another type of survey is the telephone survey where an agent of the manufacturer contacts a known purchaser directly at his or her home or business. Although the level of customer responsiveness for these types of surveys are typically higher than mail surveys, telephone surveys suffer from their overall cost. In addition, many customers dislike telephone surveys to the extent that they infringe on customer's privacy and personal lives.

Various other types of conventional surveys suffer from these and other disadvantages. For example, Internet-based survey forms require the customers to be Internet and computer savvy. Like mail surveys and phone surveys combined, Internet-based surveys suffer from low responsiveness and high implementations cost.

To counteract low survey responsiveness, some manufacturers have offered customers with incentives for completing and returning a survey. Incentives typically include items of value such as rebates, free merchandise, coupons, etc. Although the incentive methodology is effective for increasing customer responsiveness, the value of the incentives offered increases the overall cost of the survey.

### SUMMARY OF INVENTION

One objective of the present invention is to effectively and efficiently predict satisfaction levels for product buyers that have not responded to buyer satisfaction surveys. This objective is advantageous because an effective prediction of buyer satisfaction for these non-responding buyers enables product manufacturers and retailers to more effectively understand and satisfy customer needs and desires.

Effectively predicting customer satisfaction can be used in a variety of manners (i.e., personalized customer call campaigns, targeted mailings and advertising campaigns, incentives, etc.) to ultimately increase customer satisfaction. Increasing customer satisfaction in the automotive industry can translate into millions of dollars in increased annual revenue.

Another objective of the present invention is to effectively and efficiently predict satisfaction levels for customers based on current knowledge, such as customer data, purchase data, warranty claim and repair data, and available survey response data. This objective is advantageous because it builds analytically upon existing data and does not require all known buyers for a given product to complete a survey. Accordingly, the cost of implementing the present invention is low.

In meeting these and other objects, feature and advantages of the present invention, a preferred methodology for building a buyer satisfaction prediction model is provided. The preferred methodology may be computer-implemented and includes presenting a buyer satisfaction survey to at least a portion of a buyer base that has purchased one or more motor vehicles. For each buyer that completes the survey, joining that buyer's survey response data with that buyer's purchase and warranty claim data to create an aggregate of buyer satisfaction for the portion of the buyer base that completed the survey. Next, a buyer satisfaction prediction model is constructed based on the aggregate of customer satisfaction.

Input data may include demographic data, purchase data, and warranty claim The method may additionally include identifying and ranking a set of independent variables based on the aggregate of buyer satisfaction. The independent variables may be ranked according to their predictive ability. The predictive ability of the set of independent variables may be calculated based on variable entropy. A machine learning methodology may be implemented to build the buyer satisfaction prediction model. The machine learning methodology may be a decision tree, a neural network, logistic regression, or other machine learning methodology. Recursive modeling may be utilized to implement the decision tree.

The above objects and other objects, features, and advantages of the present invention are readily apparent from the following detailed description of the best mode for carrying out the invention when taken in connection with the accompanying drawings.

### BRIEF DESCRIPTION OF DRAWINGS

FIG. 1 is a chart illustrating an example relationship between hypothetical changes in buyer satisfaction and impact value, in accordance with the present invention;

FIG. 2 shows an example lift curve for a hypothetical total cost variable, in accordance with the present invention;

FIG. 3 is a graph representing a combined effect of hypothetical buyer age and warranty visit data, in accordance with the present invention;

FIG. 4 illustrates a hypothetical decision tree in accordance with the present invention; and

FIG. 5 is a block flow diagram illustrating a methodology for implementing a preferred embodiment of the present invention.

### DETAILED DESCRIPTION

One embodiment of the present invention includes a method for predicting buyer satisfaction. More specifically, and in accordance with a preferred embodiment, buyer data, warranty data and available survey data are combined, analyzed and processed in an innovative manner to generate a model for predicting satisfaction levels for buyers who have not actively participated in a survey process.

### Data Collection

One step of the preferred embodiment includes collecting relevant data. Relevant data may include but is not limited to conventional buyer survey data, product warranty data and buyer data.

Survey data depends on the content and architecture of the survey and may vary widely. A preferred buyer survey inquires about buyers' general level of satisfaction with the product. A typical response to this survey ranges on a five-point scale: (1) completely satisfied, (2) very satisfied, (3) fairly well satisfied, (4) somewhat dissatisfied, and (5) very dissatisfied. Preferably, surveys are conducted at regular intervals after a buyer has taken delivery or possession of the product at issue.

Warranty data includes historical buyer warranty claims for the product or product line over a given time period (e.g., 10 years). Warranty claims provide helpful data including the types of problems buyers have experienced with the product, whether those problems were resolved, the cost to resolve those problems and the number of repeat visits or repairs to fix a given problem.

Buyer data is typically collected at the point-of-sale and includes information such as buyer demographics, behaviors, dates of sale, price paid, repeat purchases, etc. Preferably, buyer data is collected over the same time period as the warranty data (e.g., 10 years).

### Process Data

Another step of the preferred embodiment includes processing the collected data. Data processing in accordance with the present invention may include a variety of data processing sub-steps. Data processing in accordance with the present invention may be computer implemented. Those of skill in the art are generally familiar with computer implementation of data processing.

One data processing sub-step includes joining the collected data for buyers who have completed a survey response. Collected data is joined according to a common thread such as product serial number. Consider, for example, implementing the present invention in the automotive industry and, more specifically, with regard to automobiles sold by a particular automobile manufacturer. Collected data such as buyer, survey and warranty data can be joined according to vehicle identification number.

Another data processing sub-step is capturing, for a given product, all warranty claims that occurred between the time a particular buyer took possession of the product and the time that buyer completed a survey.

Another data processing sub-step includes creating an aggregate of buyer satisfaction based on the joined data. In dealer-oriented industries, this sub-step might be carried out on a dealer-by-dealer basis over a selected period of time. In one embodiment, the aggregate of buyer satisfaction is an average buyer satisfaction score based on all joined survey responses (by dealer, if applicable). This aggregate is then applied to all buyers who have received service from that dealer over the selected time period, regardless of whether those buyers have completed a survey response.

Another data processing sub-step includes compiling buyer satisfaction variables. This step involves identifying a set of variables that define a buyer's level of satisfaction with the purchased product. Table 1 contains a hypothetical set of such variables that may be compiled in accordance with the automotive industry example.

TABLE 1
Key Areas in the Warranty Experience

| | Time of | | |
|---|---|---|---|
| Differentiating Factors | Incident(s) | Intensity | Treatment |
| Demographics | Mileage | Impact | Overnight |
| Gender | Months into | Number of | service |
| Age | ownership | claims | Dealer ratings |
| Location | | Number of | After warranty |
| Region of driver | | visits | adjustment |
| Distance from driver's | | Claim type | |
| residence to dealer | | Total cost | |
| Vehicle | | Maximum cost | |
| Model | | Total buyer | |
| ESP purchased | | paid | |
| Finance type | | Labor hours | |
| Owner Loyalty | | | |
| Purchase history | | | |

Certain variables listed in Table 1 may have a greater effect on buyer satisfaction than others. In the automotive example, these variables are presented in italic typeface. Table 2 contains definitions for various variables listed in Table 1.

TABLE 2

| Variable | Definition |
|---|---|
| Impact | Impact is the product of the warranty claim frequency and the |
| | severity of the claim type. As an automotive example, |
| | a warranty claim relating to vehicle braking possesses |
| | a greater severity than a warranty claim relating to a |
| | vehicle audio system. |
| Number of | Cumulative number of individual warranty claims |
| claims | experienced by a buyer. |
| Total cost | Cumulative gross cost of all claims experienced by a buyer. |
| Maximum | Dollar amount of the most costly warranty claim |
| cost | experienced by the buyer. |
| Total paid | Cumulative buyer-paid amount for all claims. |
| Dealer | Individual dealer service rating relating to the warranty work |
| ratings | performed (where available). A twelve-month moving |
| | average of dealer service ratings may be used to fill gaps. |
| Overnight | Cumulative number of warranty service visits requiring |
| repairs | 5 or more labor hours to complete. |

Yet another data processing sub-step includes converting warranty claim data to buyer satisfaction variables. The objective of this processing sub-step is to convert available warranty claim data into meaningful variables for buyer satisfaction analysis.

In one embodiment, warranty data is organized around the concept of a “claim”. With some exceptions, a claim is a single buyer-initiated issue related to a single product. The reason for the warranty claim is recorded under a buyer concern code which is one of several of different codes representing a majority of problems that may occur with the product at issue.

The Impact variable matches the buyer concern codes from actual warranty claims with severity values for the buyer concern codes. One way to define severity values for buyer concern codes is through buyer surveys. Thus, the Impact variable is a measure of the buyer-reported dissatisfaction with a particular product problem. Preferably, severity codes are based on a normalized scale (e.g., 10-point scale). Higher scale values indicate more severe buyer concerns.

Table 3 shows an example of how to convert hypothetical vehicle warranty claims data for a particular vehicle into buyer satisfaction variables in accordance with a preferred embodiment of the present invention. For vehicle identification number 123ABC, there are three warranty claims: two claims occurred on Jun. 6, 1999, and one occurred on Jul. 20, 1999. By aggregating the claims, visits, cost, overnight visits and severity, we construct a picture of the vehicle owner's warranty experience.

TABLE 3

| | | | Labor | | |
|---|---|---|---|---|---|
| VIN | Repair Date | Cost | Hours | Concern | Severity |
| 123ABC | Jun. 6, 1999 | $120.00 | .5 | Brakes noisy | 5 |
| 123ABC | Jun. 6, 1999 | $300.00 | 1 | Shifts rough | 7 |
| 123ABC | JuL. 20, 1999 | $1200.00 | 5.7 | Shifts rough | 7 |
| Totals | | $1620.00 | 7.2 | | 19 |

The hypothetical warranty history for VIN 123ABC shown in Table 3 has three claims, two visits, a total cost of $1620.00, a maximum visit cost of $1200.00, one overnight visit (e.g., a visit with more than five labor hours), and a total impact value of 19. Notably, Table 3 does not contain all of the relevant variables generated from the warranty claims for VIN 123ABC.

### Variable Analysis

Another step of the preferred embodiment includes analyzing buyer satisfaction variables. One objective of this analysis is to understand the relationship between different levels of buyer satisfaction and various predictive variables.

One of the issues to consider when analyzing buyer satisfaction variables is how to develop a unified view of buyer satisfaction where more than one discrete level exists (e.g., completely satisfied, very satisfied, somewhat satisfied, somewhat dissatisfied, and very dissatisfied). In most cases, a small percentage of surveyed buyers will rank their level of satisfaction as very dissatisfied. In such cases, the buyers responding either very dissatisfied or somewhat dissatisfied can be combined quantitatively.

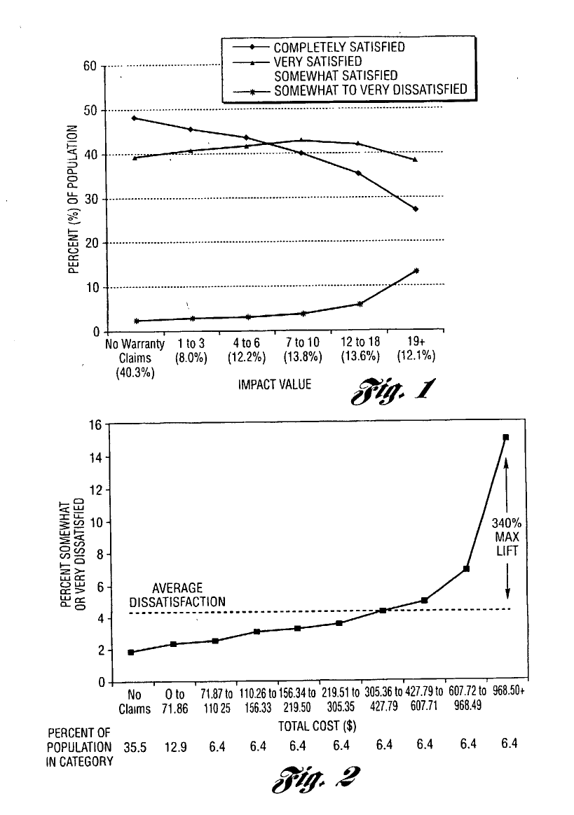

FIG. 1 is a chart illustrating an example relationship between hypothetical changes in buyer satisfaction and impact value. The vertical axis indicates the percent of various buyer satisfaction categories. The horizontal axis indicates ranges of impact values. Based on the hypothetical data, those buyers with no warranty claims represented 40.3% of the population. In this group, 48.5% of these buyers reported being completely satisfied, 39.5% very satisfied, 9.9% somewhat satisfied, and 2.1% somewhat to very dissatisfied. As the Impact value increases (i.e., the warranty experience worsens), there is a large drop in the percentage of buyers listing themselves as completely satisfied and a corresponding increase in the percentage of buyers reporting themselves as somewhat satisfied and somewhat to very dissatisfied.

At least three options exist for creating a unified view of buyer satisfaction based on data such as that represented in FIG. 1. One option is to assign a numeric value to each of the satisfaction categories. Another option is to map the lower (e.g., four) categories into a less than completely satisfied category. A third option is to map the upper (e.g., three) categories and compare them to the lower (e.g., two) categories. This option provides a view of data similar to direct marketing, where survey response rates are typically very low. Additionally, this third option involves a concept known as “lift” to measure the effectiveness of the predictive models. The concept of lift is described in greater detail below.

One sub-step associated with variable analysis includes ranking predictive variables. In accordance with a preferred embodiment of the present invention, predictive variables are ranked according to their predictive ability as measured by a machine learning metric known as Entropy. Table 4 contains a ranked listing of hypothetical predictive variables associated with warranty claims in the automotive industry.

TABLE 4

| | | Relative Contribution to Model | |
|---|---|---|---|
| | Variable | Entropy Value | 10 pt Scaling |
| Warranty | Impact | 7.017 | 10 |
| Variables | Total Cost | 6.966 | 9.9 |
| | Number of Claims | 6.661 | 9.5 |
| | Number of Repairs | 6.152 | 8.8 |
| | Maximum Cost | 5.343 | 7.6 |
| | (of any one claim) | | |
| | Cost per Visit | 4.443 | 6.3 |
| | Max TIS (claim near end of | 3.322 | 4.7 |
| | warranty | | |
| | Overnight Repairs | 3.265 | 4.7 |
| | Min TIS (claim first three | 2.636 | 3.5 |
| | months of ownership) | | |
| | Total Paid (total buyer | 2.446 | 3.5 |
| | out-of-pocket cost) | | |
| Non | Age | 0.683 | 1.0 |
| Warranty | Dealer Service Satisfaction | 0.537 | 0.8 |
| Variables | Financing Type | 0.155 | 0.2 |
| | Prior Purchase with same | 0.067 | 0.1 |
| | dealer | | |
| | Purchase of another vehicle | 0.063 | 0.1 |
| | before survey | | |
| | Gender | 0.059 | 0.1 |
| | Distance for dealership | 0.059 | 0.1 |
| | Number purchases in | 0.048 | 0.1 |
| | previous 8 yrs before | | |
| | survey | | |
| | Delivery Type | 0.048 | 0.1 |
| | Number purchase in | 0.012 | 0.0 |
| | previous 5 yrs before | | |
| | survey | | |

Entropy can be defined according to Equations 1 and 2 as:

$$Entropy ( S ) = {\sum }_{i = 1}^{n} purity ( {S}_{i} ) ,$$

where

purity(S)=−p₋log₂p₊−p₋log₂p₋,

where n is the number of categories (or bins) for an independent variable, S is a sample of training examples, p₊ is the proportion of positive examples in S, and p₋ is the proportion of negative examples in S.

For example, if the impact variable is split into three categories high, middle, and low the Entropy value is the sum of purity(high), purity(middle), and purity(low).

To aid in understanding these results, a ten-point normalized scale can be implemented to show the relative contribution of the variables to the prediction of buyer satisfaction.

Utilizing the third option for creating a unified view of buyer satisfaction above, an explanatory value of a particular variable can be described in terms of a concept known as lift. Lift can be defined as the percentage of a particular category in a subpopulation divided by the percentage of the same category in the overall population. For example, a subpopulation where 9.2% of the buyers indicated they were somewhat to very dissatisfied would have a lift of 214%.

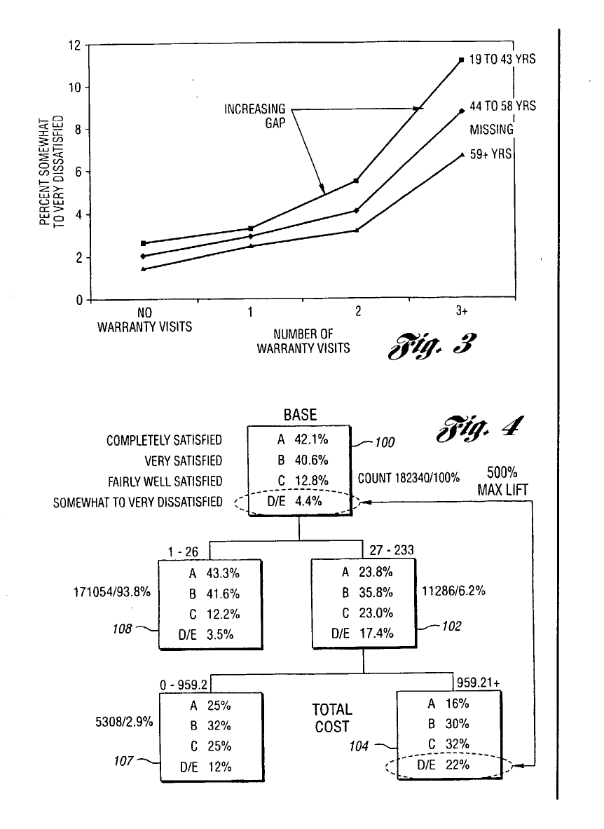

FIG. 2 shows an example lift curve for the hypothetical total cost variable in Table 4. The average dissatisfaction (shown on the graph as a dashed line) represents the average percentage of buyers listing themselves as somewhat to very dissatisfied for the entire population. Buyers with no warranty claims (e.g., no warranty claims up to 21 months-in-service) have less than half the dissatisfaction rate as the overall population (2.3%). For the subpopulation with the highest total cost (i.e., over approximately $960), the lift over the average dissatisfaction is 340%. The graph shows that dissatisfaction grows fairly linearly with increasing total cost until approximately the $600 point, where dissatisfaction increases rapidly. This is particularly true of the last point where dissatisfaction jumps over 100% from its previous value. The non-linear effect of increasing warranty experience is also present when viewing the curves for impact, number of claims, number of repairs, maximum cost and cost per claim.

FIG. 3 graphically represents the combined effect of the hypothetical buyer age and warranty visit data presented in Table 4. In this example, buyer age is grouped into three distinct clusters, younger buyers of 19 to 43 years, middle age buyers of 44 to 58 years and older buyers of 59+ years. In one embodiment, these groupings can be chosen by merging ages that have statistically similar percentages of somewhat or very dissatisfied buyers.

In this example, buyers of all ages that have no warranty visits (e.g., no warranty experience) report slightly different dissatisfaction rates, with the younger age groups reporting higher dissatisfaction rates than the older age groups. Buyers who have had one warranty visit all show a small increase in buyer dissatisfaction. However, a comparison of buyers with two warranty visits and buyers with three or more warranty visits shows an increasing gap between the different age groups with increasing warranty visits. Thus, in this example, buyers 19 to 43 years old are a third more likely to be dissatisfied than owners 59 years or older when they experience three or more warranty visits.

### Build a Predictive Model of Buyer Dissatisfaction

Another step of the preferred embodiment includes building a predictive model to predict the buyer satisfaction level of buyers that have not participated in buyer satisfaction surveys.

In accordance with a preferred embodiment of the present invention, a form of supervised machine learning is used to build the predictive model of buyer satisfaction. This can include any algorithm that uses pre-classified historical training examples to predict future examples. Examples of supervised machine learning algorithms include decision trees, neutral networks, rule learning algorithms and logistic regression.

In one embodiment, decision trees use a method known as recursive partitioning to build the predictive model. As with logistic regression, recursive partitioning uses a set of independent variables to predict a single dependent variable. Recursive partitioning includes several steps including: (i) finding the independent variable with the greatest Entropy value, (ii) creating bins for the independent variable where each bin contains a number of examples (i.e., buyer satisfaction and associated warranty variables, etc.) greater than the minimum bin size C, and (iii) for each of the bins containing a number of examples greater than the stopping size S created in step (ii), repeat step (i) or else stop. Thus, the recursive partitioning algorithm continues to create bins until the bin size becomes smaller than S. Constants S and C are user-defined.

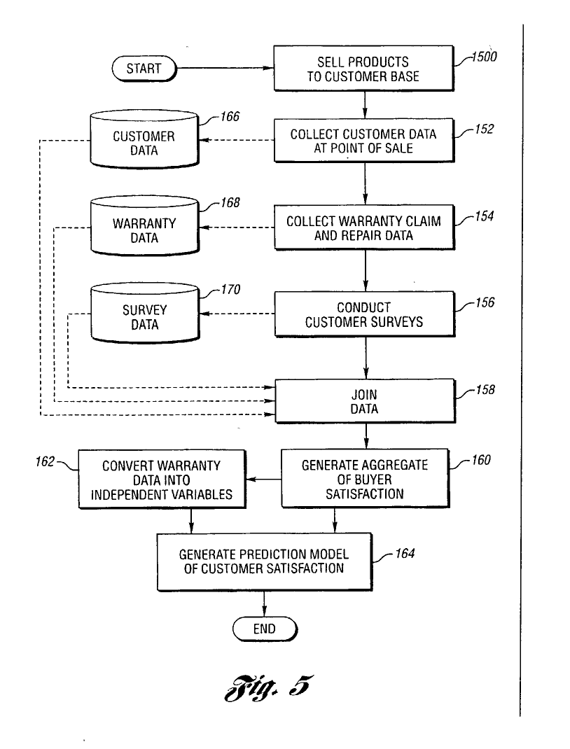

Using the model built by the decision tree we can more accurately predict the satisfaction level of individual buyers than using any single variable. FIG. 4 illustrates a hypothetical decision tree generated in accordance with a preferred embodiment of the present invention. As an example, consider the path through boxes 100, 102 and 104. At the top box 100 (“Base”) of the decision tree is the training set used to build the model. Where the impact variable is greater than the value 26, the percentage of buyers listing themselves as somewhat to very dissatisfied increases from 4.4% to 17.4% (compare categories D/E in boxes 100 and 102). Only 3.5% of the buyers with impact values of less than 27 list themselves as either somewhat or very dissatisfied (box 108). Buyers with impact values greater than 26 represent 6.2% of the training set (box 102). This group is further split into buyers having more than approximately $960 in warranty repairs (box 104) and those having less than this amount or no warranty claims (box 107). The former case represents 3.3% of the training set, where 22% of the buyers indicate they are somewhat to very dissatisfied (box 104).

FIG. 5 illustrates a methodology for implementing a preferred embodiment of the present invention. Notably, this methodology may be rearranged, adapted and/or modified to best fit a particular implementation of the present invention. In a hypothetical implementation of the present invention, products are sold to a customer base as represented in block 150. At the point of sale, customer data (e.g., customer demographic information, purchase information, etc.) is collected, as represented in block 152. Point of sale data is collected and maintained in customer data database 166. Throughout the customer's ownership of the purchased product, warranty claim and repair data is collected as warranty claims and repairs are made to the product. Warranty claim and repair data is collected and stored in warranty data database 168. At random or regularly scheduled intervals of a customer's product ownership, customer surveys are conducted as represented in block 156. Survey response data is stored in survey data database 170.

Customer data 166, warranty data 168, and survey data 170 are collectively joined as represented in block 158. Based on the joined data, an aggregate of buyer satisfaction is generated as represented in block 160. Additionally, warranty data is converted into independent variables as represented in block 162. Based on the joined data 158, the aggregate of buyer satisfaction 160, and the converted warranty claim data 162, a prediction model of customer satisfaction is generated as represented in block 164.

While the best mode for carrying out the invention has been described in detail, those familiar with the art to which this invention relates will recognize various alternative designs and embodiments for practicing the invention as defined by the following claims.

1. A method for constructing a satisfaction prediction model for motor vehicle buyers, the method comprising:
presenting a buyer satisfaction survey to at least a portion of a buyer base for one or more motor vehicles;
for each buyer that completes the survey, joining the buyer's survey response data with the buyer's transactional and warranty claim data to create an aggregate of buyer satisfaction for the portion of the buyer base that completed the survey; and
constructing a satisfaction prediction model for at least one motor vehicle buyer that has not completed the survey based on the aggregate of buyer satisfaction.

2. The method of claim 1 additionally comprising predicting buyer satisfaction for a motor vehicle buyer.

3. The method of claim 1 additionally comprising predicting consumer behavior for a potential motor vehicle buyer.

4. The method of claim 1 wherein a machine learning method is implemented to construct the buyer satisfaction prediction model.

5. The method of claim 4 wherein the machine learning method is a decision tree.

6. The method of claim 5 wherein recursive modeling is implemented to implement the decision tree.

7. The method of claim 4 wherein the machine learning method is a neutral network.

8. The method of claim 4 wherein the machine learning method is logistic regression.

9. The method of claim 1 additionally comprising identifying and ranking a set of independent variables based on the aggregate of buyer satisfaction.

10. A computer-implemented method for modeling motor vehicle buyer satisfaction, the method comprising:
receiving input data including survey data, purchase data and warranty claim data;
processing the input data; and
outputting a prediction of motor vehicle buyer satisfaction based on the processed input data.

11. The method of claim 10 wherein machine learning is implemented to the input data.

12. A method for constructing a satisfaction prediction model for motor vehicle buyers, the method comprising:
presenting a buyer satisfaction survey to at least a portion of a buyer base for one or more motor vehicles;
a step for creating an aggregate of buyer satisfaction based on the buyer's survey response data, transactional data, and warranty claim data; and
a step for constructing a satisfaction predicate model for at least one motor vehicle buyer based on the aggregate of buyer satisfaction.

13. The method of claim 12 wherein a machine learning method is implemented to construct the buyer satisfaction prediction model.

14. The method of claim 13 wherein the machine learning method is a decision tree.

15. The method of claim 14 wherein recursive modeling is implemented to implement the decision tree.

16. The method of claim 13 wherein the machine learning method is a neutral network.

17. The method of claim 13 wherein the machine learning method is logistic regression.

18. The method of claim 12 additionally comprising identifying and ranking a of independent variables based on the aggregate of buyer satisfaction.
